(19) United States
(12) Patent Application Publication
(10) Pub. No.: US 2026/0300033 A1
(43) Pub. Date: Oct. 1, 2026

(54) HYBRID COMPUTE MANAGEMENT ENGINE IN A CLOUD ACCESS MANAGEMENT SYSTEM

(71) Applicant: Microsoft Technology Licensing, LLC, Redmond, WA (US)

(72) Inventors: Stuart Hillary SCHAEFER, Kirkland, WA (US); Paul Allan MCDANIEL, Redmond, MA (US); Tucker Cunningham BURNS, Issaquah, WA (US); Gabriel HERA, Redmond, WA (US); Raymond Matthew RESKUSICH, Seattle, WA (US); Bharath Reddy KODURU, Kirkland, WA (US); Siva Prasad BALASUBRAMANIYAM, North Vancouver (CA); Viswambharan KASTURI RANGARAJAN, Redmond, WA (US); Matthew Ronald SHADBOLT, Melbourne (AU); Sneha SULTANIA, Seattle, WA (US)

(21) Appl. No.: 19/094,538

(22) Filed: Mar. 28, 2025

(51) Int. Cl. G06F 9/50

(52) U.S. Cl. CPC G06F 9/5083; G06F 9/5033; G06F 9/5038

(57) ABSTRACT

Methods, systems, and computer storage media for providing hybrid compute management using a hybrid compute management engine are described. Hybrid compute management refers to the dynamic orchestration of artificial intelligence (AI) workloads from a remote client to an AI workload cloud-based compute resource to optimize performance and resource utilization. The hybrid compute management engine enables AI-powered features on the remote client by dynamically offloading inferencing workloads to the AI workload cloud-based compute resource in an external compute environment while maintaining a seamless user experience. A hybrid compute framework associated with the hybrid compute management engine operates to redirect AI workloads from the remote client to the AI workload cloud-based compute resource, ensuring that these AI-powered feature associated with the remote client available even in the absence of dedicated AI hardware. An AI processing orchestrator directs workloads from a remote client to the cloud-based compute resource based on policy-driven execution rules.

### BACKGROUND

Users rely on computing environments with applications and services to accomplish computing tasks. Distributed computing systems and/or cloud computing platforms host and support different types of applications and services in managed computing environments. In particular, a cloud computing platform can implement a cloud access management system that provides access management functionality for different types of cloud computing offerings. For example, a cloud access management system can provide local clients access to remote clients – such as managed desktop services that include virtual machines assigned to individual users as virtual desktop devices configured with productivity, security, and collaboration tools.

### SUMMARY

Various aspects of the technology described herein are generally directed to systems, methods, and computer storage media for, among other things, providing hybrid compute management using a hybrid compute management engine of a cloud access management system. Cloud access management supports access management operations for providing remote client sessions between local clients and remote clients to enable users to seamlessly access cloud-based resources. Hybrid compute management refers to the dynamic orchestration of artificial intelligence (AI) workloads across remote and cloud-based computing environments to optimize performance and resource utilization. The hybrid compute management engine enables AI-powered features on remote clients by dynamically offloading inferencing workloads to external compute environments while maintaining a seamless user experience. In particular, remote clients that lack access to Neural Processing Units (NPUs) are presently unable to adequately support advanced AI-powered features. To bridge this gap, a hybrid compute framework associated with the hybrid compute management engine operates to redirect AI workloads from remote clients to a cloud-based AI workload compute resource, ensuring that these AI-powered features remain available even in the absence of dedicated AI hardware. The hybrid compute management engine may evaluate hardware capabilities, workload requirements, and/or compute availability to determine execution path(s) for the AI workloads. An AI processing orchestrator directs AI workloads – associated with a local client in a remote client session – to a cloud-based AI workload compute resource (e.g., a cloud graphics processing unit (GPU) cluster) based on policy-driven execution rules. A scheduler, offloading mechanism, and transport layer optimize workload distribution. Processed AI inference results are returned transparently, allowing users to experience AI features as if running natively, ensuring parity across physical and virtualized environments.

Conventionally, cloud access management systems are not configured with comprehensive computing logic and infrastructure to effectively offload inferencing workloads from remote clients to external compute environments to ensure execution with dedicated hardware. A conventional cloud access management system (e.g., Virtual Desktop Infrastructure “VDI”) faces significant limitations when attempting to support the dynamic offloading of AI inferencing workloads to external dedicated hardware for several reasons. First, VDIs are not designed to recognize or leverage specialized hardware like NPUs, which are important for optimizing AI task execution. This lack of hardware awareness impedes the VDI’s ability to intelligently offload workloads to external dedicated hardware.

Additionally, VDIs are generally not engineered for the low-latency, real-time processing demands of AI inferencing, which is essential for performance in time-sensitive applications. Furthermore, offloading workloads to external cloud-based resources requires sophisticated resource management, including dynamic orchestration and allocation of the workloads across distributed environments, a functionality that conventional VDIs typically do not provide. These factors result in conventional VDIs being poorly equipped for the efficient management and execution of AI workloads requiring dedicated hardware.

A technical solution – to the limitations of conventional cloud access management systems – can include providing a hybrid compute management engine that includes an AI processing orchestrator, a policy-driven AI workload management model, an AI workload offloading mechanism, and a high bandwidth transport layer. The AI processing orchestrator dynamically determines whether an AI workload should be executed on the remote client or offloaded. The AI orchestrator applies policy-driven AI workload management to enforce execution rules associated with compute resource selection, AI model versioning, and workload distribution strategies.

The AI orchestrator selects an optimal or preferred execution path for the AI workload. The AI workload offloading mechanism transfers AI workloads from remote clients to external compute environments and ensures that AI tasks are securely offloaded to a cloud-based AI workload compute resource (e.g., cloud GPU clusters). The high-bandwidth transport layer facilitates low-latency data transfer between remote clients and external AI compute resources. This ensures efficient workload redirection and rapid return of inference results, while preventing or mitigating noticeable execution delays. In this way, the hybrid compute management engine preserves seamless execution, allowing users to experience AI-powered features without disruption.

In operation, in a first embodiment, an AI workload request associated with a remote client is accessed at an AI processing orchestrator. Based on an AI workload management policy, a determination is made to offload processing of the AI workload request to a cloud-based AI workload compute resource. The AI workload request is communicated to cause execution of the AI workload request. In response to communicating the AI workload request, AI workload results are received. AI workload results are communicated to cause display of the AI workload results on an interface associated with the remote client.

In a second embodiment, a remote client is provisioned, the remote client is provisioned with an AI processing orchestrator that supports offloading AI workloads from the remote client based on AI workload management policies. An AI workload request is accessed at an AI workload router from the AI processing orchestrator. The AI workload request is identified to be processed using an AI workload distribution engine associated with a cloud-based AI workload compute resource. The AI workload is communicated to cause execution of the AI workload request. AI workload results are communicated to the AI processing orchestrator to cause display of the AI workload results on an interface associated with the remote client.

In a third embodiment, an AI workload request is access at an AI workload router. The AI workload request is accessed from an AI processing orchestrator. The AI workload request is identified to be processed using an AI workload distribution engine associated with a cloud-based AI workload compute resource. The AI workload request is communicated to cause execution of the AI workload request. In response to communicating the AI workload request, AI workload results for the AI workload request are received. The AI workload results are communicated to the AI processing orchestrator to cause display of the AI workload results on an interface associated with a remote client.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

### BRIEF DESCRIPTION OF THE DRAWINGS

The technology described herein is described in detail below with reference to the attached drawing figures, wherein:

FIG. 1A is a block diagram of an exemplary cloud access management system including a hybrid compute management engine, in accordance with aspects of the technology described herein;

FIG. 1B is a flow diagram associated with providing hybrid compute management using a hybrid compute management engine, in accordance with aspects of the technology described herein;

FIG. 2 is a block diagram of an exemplary cloud access management system including a hybrid compute management engine, in accordance with aspects of the technology described herein;

FIG. 3 provides a first exemplary method of providing hybrid compute management using a hybrid compute management engine, in accordance with aspects of the technology described herein;

FIG. 4 provides a second exemplary method of providing hybrid compute management using a hybrid compute management engine, in accordance with aspects of the technology described herein;

FIG. 5 provides a third exemplary method of providing hybrid compute management using a hybrid compute management engine, in accordance with aspects of the technology described herein;

FIG. 6 provides a block diagram of an exemplary cloud access management system suitable for use in implementing aspects of the technology described herein;

FIG. 7 provides a block diagram of an exemplary distributed computing environment suitable for use in implementing aspects of the technology described herein; and

FIG. 8 provides a block diagram of an exemplary computing environment suitable for use in implementing aspects of the technology described herein.

### DETAILED DESCRIPTION

### Overview

A cloud access management system provides access management functionality for different types of cloud computing offerings. The cloud access management system may be a centralized platform designed to facilitate secure and efficient access to cloud-based resources from various devices, including traditional desktops, laptops, and thin clients. The cloud access management system can include software, hardware, and infrastructure components that enable users to authenticate, connect, and interact with remote resources hosted in the cloud. The cloud access management system manages operations associated with user identities, permissions, and access policies to ensure that only authorized users can access specific resources. Additionally, it may incorporate features such as single sign-on (SSO), multi-factor authentication (MFA), and session management to enhance security and user experience.

By way of context, NPUs (Neural Processing Units) are specialized hardware designed to accelerate AI and machine learning tasks in computers. In PCs (e.g., local clients), NPUs enhance the performance of AI-powered features by efficiently processing complex neural network computations. Unlike traditional CPUs, which handle general tasks, NPUs are optimized for parallel processing and deep learning algorithms, improving speed and reducing energy consumption. NPUs enable real-time AI applications, such as image and speech recognition, natural language processing, and autonomous systems. By processing AI tasks on NPUs, PCs can deliver more responsive, intelligent features, making them essential for advanced AI-driven functionalities.

Local clients with NPUs efficiently execute AI tasks, enabling effective operation of AI-powered features like user history recall and advanced file search techniques. For example, the user history recall feature may utilize the NPU to remember and retrieve user past user activities, offering a more personalized user experience. Similarly, advanced file search techniques may utilize the NPU to provide faster and more accurate results, analyzing context associated with file content rather than just keywords. These features run seamlessly on local clients, with the NPU boosting performance and enhancing the overall user experience. However, when a user connects to a remote client that lacks NPU hardware, these AI-powered features may not be available at all, impacting the user experience and performance they are accustomed to on their local client.

Conventionally, cloud access management systems are not configured with a comprehensive computing and logic and infrastructure to effectively offload inferencing workloads from remote clients to external compute environments to ensure execution with dedicated hardware. Traditional VDIs are typically designed to handle general-purpose computing tasks and may not be aware of specialized hardware like NPUs or cloud GPU clusters. Offloading AI workloads to dedicated hardware requires a VDI to intelligently detect when and where offloading should occur and manage the transition between the remote client and the external compute environment. VDIs are usually not equipped with this level of hardware resource recognition or optimization to handle specialized workloads, making them unsuitable for managing AI inference tasks that require dedicated hardware acceleration.

By way of context, AI inferencing is the process by which a trained artificial intelligence model analyzes input data and generates an output—such as a prediction, classification, or decision—based on learned patterns. It represents the runtime application of a model’s knowledge, translating abstract weights and structures into actionable, context-specific outcomes with minimal latency, and is foundational to deploying AI systems in real-world environments. AI inferencing often requires low-latency and real-time processing to function effectively, especially for applications like voice recognition or autonomous systems. Traditional VDIs are typically designed to provide a consistent user experience over a network, but they are not optimized for real-time AI workloads. The VDI might introduce delays due to network overhead, making it difficult to dynamically offload workloads to an external compute environment where a cloud-based AI workload compute resource is located, affecting performance and responsiveness.

Offloading AI workloads to external systems with dedicated processor hardware requires dynamic and efficient resource management, which is not a standard feature of traditional VDI systems. Managing resources across distributed environments (e.g., remote clients, VDI servers, and cloud-based AI workload compute resources) adds complexity. These VDIs often lack the automation and orchestration tools required to efficiently allocate resources, monitor workloads, and ensure seamless transitions between remote client sessions and external dedicated hardware. This limits the ability to offload and manage AI inferencing tasks in a scalable and optimized way. More generally, VDIs were not built with the flexibility, low-latency performance, or advanced hardware management needed to dynamically offload AI inferencing workloads to specialized cloud-based AI workload compute resources. As such, a comprehensive cloud access management system – with an alternative basis for executing AI workload operations – can improve computing operations and interfaces in cloud access management systems.

While the present techniques are primarily described in the context of NPUs and AI inferencing workloads, one of ordinary skill in the art will appreciate that the techniques may be applied to other specialized hardware and/or software and other workloads.

### Description of Technical Solution

At a high level, the hybrid compute management engine enables AI-powered features on remote clients by dynamically offloading inferencing workloads to external compute environments while maintaining a seamless user experience. In particular, remote clients that lack access to NPUs face challenges in supporting these advanced AI features. To bridge this gap, a hybrid compute framework associated with the hybrid compute management engine is provided to redirect AI workloads from remote clients to a cloud-based AI workload compute resource, ensuring that these AI features remain available even in the absence of remote client NPUs.

The hybrid compute management engine compute includes an AI processing orchestrator that determines how and where AI workloads should be executed. The AI processing orchestrator acts as a dynamic workload director, determining an execution path for the AI workloads. The AI processing orchestrator’s decision-making process can be driven by a policy-based workload management model, which defines execution rules based on compute resource selection, AI model versioning, and/or workload distribution strategies. For example, the AI processing orchestrator may assess one or more of hardware capabilities, workload requirements, or compute availability to decide whether a task should be executed on the remote client or offloaded to a cloud GPU cluster.

The AI processing orchestrator includes several components that facilitate this workload management, including a scheduler that prioritizes and queues AI tasks, an offloading mechanism that transfers workloads to the appropriate execution environment, and a high-bandwidth transport layer that ensures fast and efficient data exchange between remote client and external AI processing units.

To maintain or improve the expected user experience, the hybrid compute management engine integrates with an AI-powered service layer of a remote client. When an AI-powered function is triggered on the remote client, the AI processing orchestrator intercepts the request and determines whether local execution of a task associated with the request is possible on the remote client. If the task cannot be executed on the remote client, the AI processing orchestrator offloads the AI workload for processing using an AI workload distribution engine that routes the AI workload for inferencing. The processed inference results are then returned to the remote client, ensuring that from the user’s perspective, the feature operates as if it were running natively on an NPU-enabled local client. This transparent redirection mechanism ensures that AI-powered service layer features remain consistent across both physical and virtualized environments.

The hybrid compute management engine provides a hybrid compute framework that enables remote-client-based execution or cloud-base execution on a cloud-based AI workload compute resource optimized for large-scale inferencing. By intelligently selecting the best or preferred execution path, the hybrid compute management engine minimizes latency, optimizes resource utilization, and ensures efficient AI workload execution across a range of remote clients. The hybrid compute management engine not only allows remote clients to support AI-powered features but also makes the solution future-proof by enabling integration with emerging AI hardware, including data center-level NPUs.

A policy-driven execution model ensures that workloads are managed efficiently, allowing AI inferencing to be performed seamlessly. As a result, AI-powered features remain fully functional on remote clients, despite the absence of NPUs. The hybrid compute management engine is designed to be scalable and adaptable to evolving AI processing needs, and a solution for extending AI capabilities beyond physical NPUs on local clients.

By way of example, a user working on a remote client via a local client needs to locate a presentation containing a specific image and handwritten notes. An AI-powered document search feature, part of the AI-powered service layer, enables the user to search for files based on content rather than just filenames. However, if the remote client lacks an NPU in its cloud computing infrastructure, it cannot execute the AI-based image and handwriting recognition model on the remote client.

With the hybrid compute management engine, in the example of a user initiating a search query, an AI processing orchestrator of the hybrid compute management engine intercepts the request and evaluates the execution options. The AI processing orchestrator consults the policy-based workload management model associated with predefined execution rules that dictate how workloads should be processed. Based on workload requirements and compute availability, the orchestrator selects an external cloud-based AI workload compute resource for execution. These policies may define compute resource selection, AI model versioning, workload prioritization, and distribution strategies. A scheduler prioritizes the request, queues it, and hands it off to the offloading mechanism, which securely transfers the AI workload to the selected cloud execution environment via the high-bandwidth transport layer. The AI model running in the cloud performs the AI operation and generates inference results.

Once the processing is complete, the processed inference results are returned to the remote client, where the AI-powered service layer integrates the response and displays the search results as if the processing had occurred on the remote client. The user experiences a fast, seamless search, without being aware that AI inferencing was offloaded to an external compute environment. This transparent AI workload redirection ensures that the AI-powered document search remains fully functional even in a cloud-based virtual desktop that lacks dedicated AI hardware.

### Example Systems and Resources

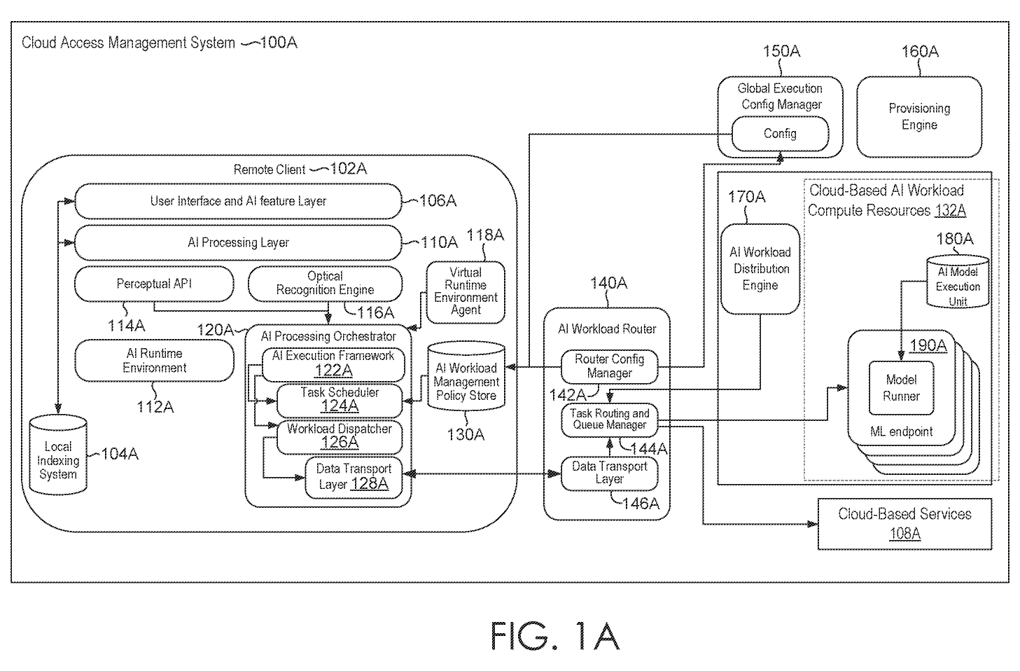

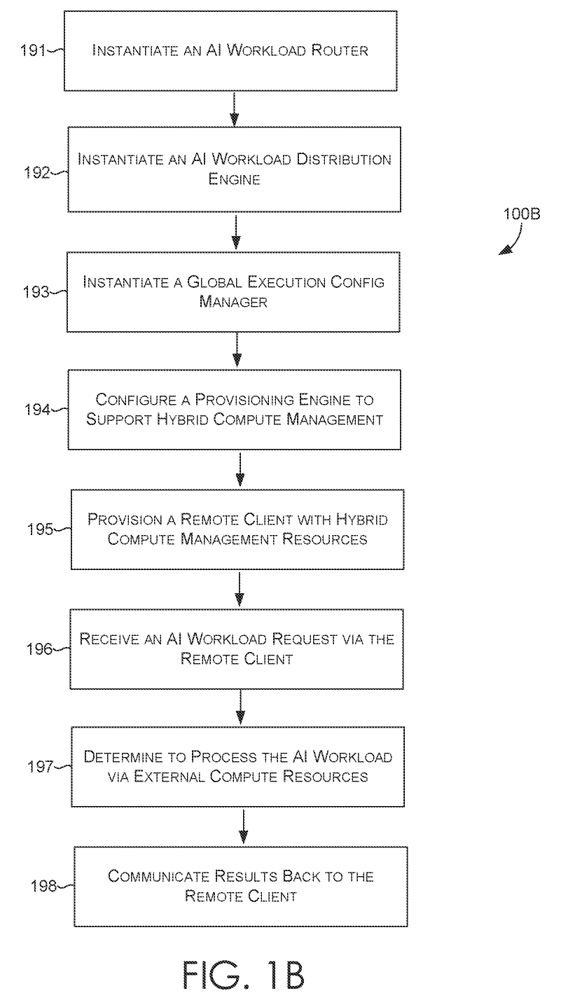

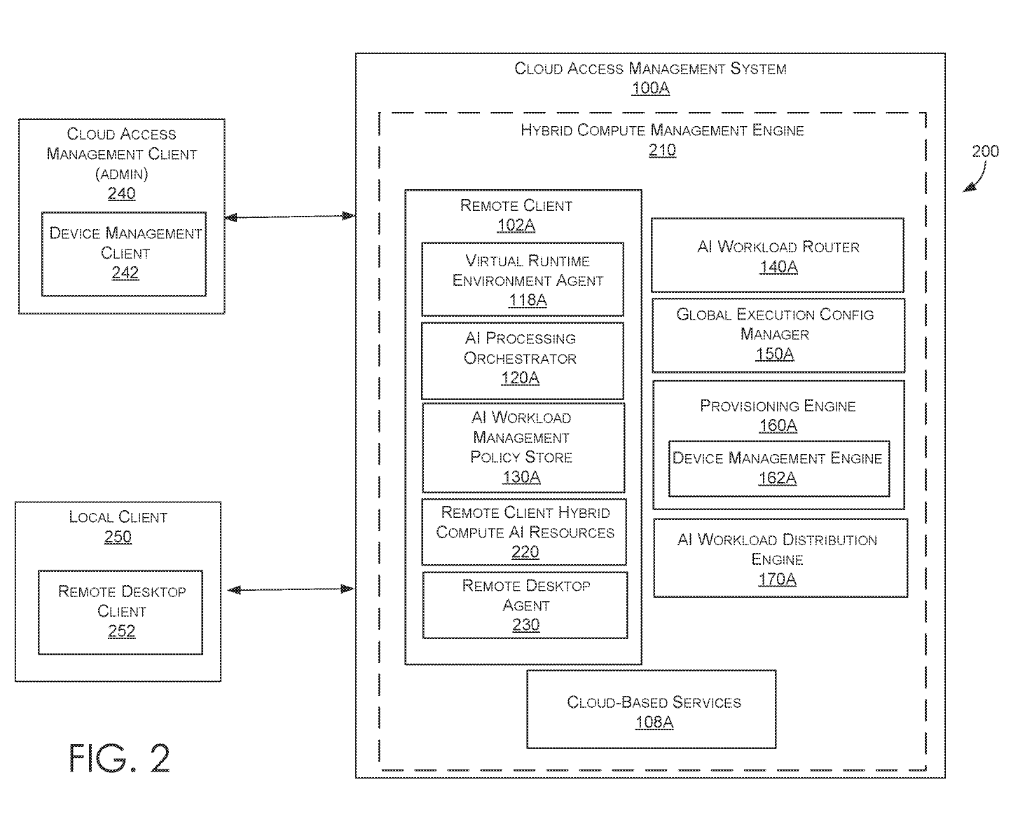

Aspects of the technical solution can be described by way of examples and with reference to FIGS. 1A, 1B and 2. FIG. 1A illustrates cloud access management system 100A, remote client 102A, local indexing system 104A, user interface and AI feature layer 106A, cloud-based services 108A, AI processing layer 110A, AI runtime environment 112A, perceptual API 114A, optical recognition engine 116A, virtual runtime environment agent 118A, AI processing orchestrator 120A, AI execution framework 122A, task scheduler 124A, workload dispatcher 126A, data transport layer 128A, AI workload management policy store 130A, AI workload router 140A, router config manager 142A, task routing and queue manager 144A, data transport layer 146A, global execution config manager 150A, provisioning engine 160A, AI workload distribution engine 170A, AI model execution unit 180A, model runner 190A (machine learning endpoint).

The cloud access management system 100A provides a centralized platform designed to facilitate access to cloud-based resources (e.g., remote client 102A). The cloud-based services 108A includes cloud-based Application Programming Interfaces (APIs) and services that integrate artificial intelligence (AI) capabilities to applications. Cloud-based services 108A provide, for example, pre-built models and tools for tasks such as image recognition, natural language processing, speech-to-text, translation, and/or decision-making.

The remote client 102A is a virtualized desktop that runs in the cloud allowing one or more users to access a cloud-based computing environment from local client(s.) The user interface and AI feature layer 106A is responsible for managing user interactions with AI-based features that are accessible via the remote client 102A. The AI processing layer 110A supports some AI inference capabilities including tasks like document scanning, object recognition, and context-aware search. In particular, the AI processing layer 110A can enable AI inference capabilities that can be performed on the remote client 102A. The perceptual API 114Ais an API layer that allows the AI-powered features interact with perception-related tasks such as image analysis, handwriting recognition, and speech-to-text.

Users interact with the remote client 102A to generate requests associated with AI-powered features (e.g., user history recall, advanced file search techniques). For example, a user searches for an image of the Eiffel Tower in their remote client, the search request can be processed using AI-based image recognition via the hybrid compute management functionality. The optical recognition engine 116A handles optical character recognition that extracts text from images or scanned documents. The local indexing system 104A assists in AI-powered features (e.g., search and recall) by organizing and indexing data on the remote client to enhance the efficiency of retrieving relevant information quickly during AI-driven tasks. For example, in an AI-powered image search application, the local index system 104 stores and indexes image metadata like tags, colors, and objects detected in images. When a user searches for a specific object, the local indexing system 104A quickly retrieves relevant images from a remote client index, enabling fast and accurate search results, thereby improving user experience by reducing search latency and ensuring precise results based on the indexed data.

The virtual runtime environment agent 118A manages the virtual environment of the remote client 102 and operates with the AI processing orchestrator 120A to enable offload AI workloads. The virtual runtime environment agent 118 supports a virtualized space that allows applications to run independently of the underlying hardware, providing a consistent and isolated execution environment. The virtual runtime environment enables communications between AI processing orchestrator 120A, applications, and the host system of the remote client 102.

The AI processing orchestrator 120A manages AI workload execution across remote clients and cloud-based AI workload compute resources 132A. The AI execution framework 122A governs the flow of AI tasks, determining whether they should run on the remote client or be offloaded to the cloud. The AI runtime environment 112A executes AI models on the remote client for AI workloads that are not identified to be offloaded a cloud-based AI workload compute resource. An AI workload request from a remote client can be optimally executed with an NPU; however, in the present example, the remote client 102A does not have direct access to NPUs.

AI processing orchestrator 120A supports executing the AI workload request via a cloud-based AI workload compute resource (e.g., an AI workload distribution engine 170A). Cloud-based AI workload compute resources 132A can refer to a scalable computing infrastructure provided by cloud computing system, such as virtual machines, GPUs, or NPUs, specifically designed to handle AI tasks like inferencing and data processing. These resources – managed with an AI workload distribution engine – are elastic, allowing on-demand provisioning and distribution of computational power based on the AI workloads.

The AI processing orchestrator 120A includes a task scheduler 124A, workload dispatcher 126A, and data transport layer 128A. The components manage workload execution timing and resource allocation, workload offloading to external compute resources, and data transfers for AI workload execution, respectively. Task scheduler 124A is responsible for prioritizing, queuing, and distributing AI workloads, ensuring efficient execution based on compute availability and performance requirements. Workload dispatcher 126A serves as the mechanism that transfers workloads between remote clients (e.g., remote client 102A) and cloud-based environments, mitigating latency and optimizing inference execution. Data transport layer 128A provides a high-bandwidth, low-latency communication channel between the remote client 102A and external compute resources, facilitating seamless workload handoff.

The AI workload management policy store 130A provides AI workload management policies having a structured framework that governs how, where, and when AI workloads are executed within a hybrid compute environment. AI workload management policies enable workload execution across local clients associated with a remote client and a cloud-based AI workload compute resource while maintaining a seamless user experience. The task scheduler 124A, workload dispatcher 126A, and task routing and queue manager 144A enforce these policies dynamically, prioritizing workload execution based on performance requirements and resource availability.

The policies can include execution rules, workload prioritization policies, and AI model selection and versioning policies. Execution rules may define where AI workloads should be executed based on hardware capabilities, compute availability, and system constraints. These policies support making a determination whether tasks should run on the remote client or on cloud compute resources. Workload prioritization policies establish how AI tasks are queued, scheduled, and executed based on urgency, resource availability, and latency requirements. Real-time tasks may be prioritized over background AI processes.

AI model selection and versioning policies may ensure that workloads use the latest AI models for accuracy and efficiency, while maintaining backward compatibility with previous versions when needed. These policies govern model updates, deployment, and execution strategies. In one embodiment, an AI workload management policy that allows dynamically offloading AI workloads based on predefined classifications based on the type of AI task, such as image recognition, natural language processing, or deep learning, and the hardware requirements (e.g., NPUs) for optimal or preferred performance. These tasks typically involve operations, such as matrix multiplications or convolutions, which are well-suited to the specialized hardware capabilities of NPUs.

The AI workload router 140A manages the interaction between cloud-based AI workload compute resources 132A and remote clients, ensuring efficient workload distribution across different regions. The AI workload router 140A acts as a distribution gateway that manages AI workload in different compute resources. The router config manager 142A includes configurations that control routing the AI workloads and it also stores execution parameters for AI workload routing. Task routing and queue manager 144A directs workloads to the appropriate AI processing units based on policy-driven decisions, ensuring low-latency execution. Data transport layer 146A provides a high-bandwidth, low-latency communication channel between the AI workload router 140A and remote client 102A facilitating seamless workload handoff.

The global execution config manager 150A provides centralized configuration and policy management, enabling the dynamic adjustment of compute allocations across different cloud environments. Provisioning engine 160A handles provisioning and licensing of remote clients with hybrid compute management functionality. Remote clients are provisioned with hybrid compute management resources that allow AI workloads to be offloaded. The provisioning engine 160A can also provision remote clients (e.g., remote client 102A) that do not include the hybrid compute management resources.

AI workload distribution engine 170A is responsible for distributing incoming AI workload requests across cloud-based AI workload compute resources 132A. An AI workload request can be received from AI workload router 140A such that the AI workload distribution engine 170A assigns the AI workload request to a cloud-based AI workload compute resource. A cloud-based AI workload compute resource, such as a cloud GPU cluster, can operate independently from the remote client and host system. The GPU cluster is hosted in the cloud, providing high-performance computing resources optimized for AI tasks like deep learning and inference processing. When the remote client initiates an AI workload, the request is sent over the network to the cloud GPU cluster, where the task is processed. The AI model execution unit 180A executes AI models using a cloud-based AI workload compute resource. For example, an AI model may support executing perception-related inferencing tasks. The model runner 190A executes the AI model workload and can be accessible based on a machine learning endpoint for handling AI workloads. Once the workload is complete, results are returned to the remote client.

By way of illustration, a user working on a remote client 102A (a virtualized desktop running in the cloud) initiates a search request via an AI-powered feature within the user interface and AI feature layer 106A. The user is searching for a scanned document that contains handwritten notes and an image of the Eiffel Tower. The request triggers multiple AI-powered processes that rely on image recognition and optical character recognition (OCR).

First, the request is handled by the AI processing layer 110A, which supports some AI inference tasks. Since the user is searching for an image and text within a document, the perceptual API 114A is engaged to process the user’s query request. The hybrid compute management engine is used to run the AI model in the cloud for query processing, and the after getting the inference results, attempts to locate relevant data within the local index system 104 on the remote client.

The virtual runtime environment agent 118A recognizes that a host machine of the remote client 102A does not have an NPU and therefore interacts with the AI processing orchestrator 120A to determine the best execution path. The AI execution framework assesses whether the task can be executed on the remote client using the AI runtime environment 112A (which handles AI models that do not rely on NPUs). Finding that remote client is insufficient, the AI processing orchestrator 120A accesses an AI workload management policy in a policy-driven AI workload management store 130A to determine whether to offload the AI workload.

The task scheduler 124A prioritizes and queues the request, ensuring that the search runs efficiently. The workload dispatcher 126A offloads the workload to a cloud-based AI compute resource via the data transport layer 128A, which ensures high-bandwidth, low-latency communication between the remote client 102A and external AI compute services. The AI workload router 140A manages the interaction between the remote client 102A and a cloud-based AI workload compute resource, ensuring that the workload is routed efficiently.

The router config manager 142A retrieves execution parameters and policies associated with the global execution config manager 150A, while the task routing and queue manager 144A identifies a route for inference execution. The workload is then sent to the AI workload distribution engine 170A, which distributes the AI task across available cloud compute resources. The AI model execution unit 180A receives the task, where an AI model specialized for image recognition and OCR is executed. The model runner 190A processes the AI inference task via a machine learning endpoint, extracting both the Eiffel Tower image and the handwritten text from the scanned document.

Once processing is complete, the AI inference results are sent back to the remote client 102A via the data transport layer 146A and data transport layer 128A, ensuring seamless integration into the user’s search results. The user sees the document listed instantly, experiencing no noticeable difference between remote-client execution and cloud execution. This transparent offloading mechanism ensures that AI-powered features remain fully functional on the remote client despite its lack of an NPU, demonstrating the efficiency and scalability of the hybrid compute management engine in handling AI workloads dynamically.

With reference to FIG. 1B, FIG. 1B illustrates a flow diagram 100B associated with providing a hybrid compute management engine using a cloud access management system. A hybrid compute management workflow can some or all of the following steps:

### Step 191 – Instantiate an AI Workload Router

The first step in implementing AI workload execution in a hybrid compute environment is instantiating an AI workload router. The AI workload router is deployed to manage AI workload interactions between remote clients and cloud-based AI workload compute resources for hybrid compute management. As part of this setup, the router config manager is integrated to define routing configurations and execution parameters, ensuring that workload execution follows structured rules. Additionally, the task routing and queue manager is deployed to enforce policy-driven execution rules, helping to maintain low-latency AI workload distribution. And data transport layer is provided as a communication channel between the AI workload router and remote clients.

### Step 192 – Instantiate an AI Workload Distribution Engine

The AI workload distribution engine is instantiated to handle incoming AI workload requests and distribute them efficiently across available a cloud-based AI workload compute resource. The AI model execution unit is also integrated into this stage to process AI inference tasks once workloads have been assigned to the cloud-based AI workload compute resource. With the AI workload router and AI workload distribution engine in place, the hybrid compute management engine can now efficiently route and allocate AI workloads based on compute availability and policy-driven execution constraints.

### Step 193 – Instantiate a Global Execution Config Manager

Global execution config manager is instantiated to centralize AI workload execution policies. Global execution config manager dynamically adjusts compute allocations across cloud regions based on real-time resource availability. To support policy-driven execution, the AI workload management policy store is integrated with the global execution config manager, ensuring that execution rules, workload prioritization policies, and AI model selection and versioning policies are applied correctly.

### Step 194– Configure a Provisioning Engine to Support Hybrid Compute Management

The provisioning engine is configured to support hybrid compute management by provisioning remote clients with the necessary hybrid compute AI processing resources. This provisioning engine is responsible for enabling or restricting access to a cloud-based AI workload compute resource ensuring that remote clients are configured according to hybrid compute management policies.

### Step 195 – Provision a Remote Client with Hybrid Compute Management Resources

The remote client is provisioned with hybrid compute management resources. The virtual runtime environment agent and AI processing orchestrator are deployed on the remote client to manage AI workload offloading, allowing workloads to be executed on either local resources or external compute environments. If local AI processing is possible, the AI runtime environment is enabled to execute AI workloads without offloading.

### Step 196 – Receive an AI Workload Request via the Remote Client

The hybrid compute management engine processes AI workload requests from a remote client. A user interacting with an AI-powered feature, such as image search or OCR, initiates a request through the user interface and AI feature layer. The request is processed and forwarded to the AI processing orchestrator, which determines the appropriate execution path.

### Step 197 – Determine to Process the AI Workload via External Compute Resources

The AI processing orchestrator accesses an AI workload management policy in the AI workload management policy store to decide whether the AI workload should be executed on the remote client or offloaded to an external compute environment. If the remote client AI workload is a type of workload associated with cloud-based AI compute processing, the workload dispatcher offloads the task via the data transport layer to the AI workload router, which routes it to a cloud-based AI compute resource.

### Step 198 – Communicate Results Back to the Remote Client

Once the AI workload has been processed, the AI model execution unit 180A sends the results back to the AI workload router. The data is then transmitted via the data transport layer to the remote client, ensuring seamless integration with the user interface and AI feature layer. This allows the user to experience AI-powered features as if the computation occurred on the remote client, even when workloads were offloaded to an external compute environment.

In this way, the hybrid compute management engine ensures that AI workload execution is optimized based on compute availability, workload priority, and policy-driven execution rules. By integrating intelligent workload routing, distribution, and provisioning, the hybrid compute system provides a scalable and efficient AI-powered experience for remote client users.

With reference to FIG. 2, FIG. 2 illustrates cloud computing environment 200, cloud access management system 200A, hybrid compute management engine 210, remote client hybrid compute AI resources 220, remote desktop agent 230, cloud access management client 240 and device management client 242, and local client 250 including remote desktop client 252; and as shown in FIG. 1A, remote client 102A, cloud-based services 108A, virtual runtime environment agent 118A, AI processing orchestrator 120A, AI workload management policy store 130A, AI workload router 140A, global execution config manager 150A, provisioning engine 160A including device management engine 162A,, and AI workload distribution engine 170A.

The hybrid compute management engine 210 is designed to facilitate AI workload execution across local, remote, and cloud-based environments. The cloud access management system 200A operates as a centralized control layer for provisioning and managing remote clients that support AI workloads. This cloud access management system 200A interacts with both administrative clients (e.g., cloud access management client 240) and local clients (e.g., local client 250) to ensure access to provisioning resources and hybrid compute resources.

The hybrid compute management engine 210 orchestrates AI workload execution, workload policy enforcement, and dynamic routing of compute tasks. This hybrid compute management engine 210 includes multiple components that contribute to management of AI workload execution. The provisioning engine 160A is responsible for provisioning remote clients (e.g., remote client 102A) with AI resources, ensuring that remote clients are configured for hybrid execution. The device management engine 162A provides lifecycle management of devices that participate in AI workload execution.

Remote client 102A is instantiated within the hybrid compute management engine 210 representing a virtualized desktop that operates in the cloud computing environment 200. Remote clients (e.g., remote client 102A) are provisioned with remote client hybrid compute AI resources 220, which allow AI inferencing capabilities to be deployed dynamically based on workload requirements. The virtual runtime environment agent 118A manages execution environments, determining whether tasks should be processed on the remote client 102A or redirected for external computation. The remote desktop agent 230 facilitates access to the remote client 102A via remote desktop agent 184.

Within the hybrid compute framework, the AI processing orchestrator 120A determines how and where AI workloads are executed. AI processing orchestrator 120A dynamically determines whether workloads should be processed on the remote client 102A or offloaded to a cloud-based AI workload compute resource. The AI processing orchestrator 120A relies on AI workload management policies in AI workload management policy store 130A, which enforce structured execution policies, workload prioritization, and AI model selection and versioning policies. AI workload management policies define execution rules based on system constraints, ensuring that workloads follow predefined paths to optimize performance and resource allocation.

To efficiently route and execute AI workloads, the hybrid compute management engine 210 incorporates an intelligent distribution framework. The AI workload router 140A directs AI tasks to the appropriate compute resource based on policy enforcement and real-time system availability. The AI workload distribution engine 170A manages workload balancing across multiple cloud-based AI processing units, ensuring that compute resources are allocated efficiently. To centralize execution policies, the global execution config manager 150A dynamically adjusts compute resource allocations, ensuring that workload distribution aligns with system constraints and real-time compute availability. The cloud-based services 108A include cloud-based APIs and services that integrate AI capabilities to applications.

Clients interacting with the hybrid compute management engine 210 include both administrative clients (e.g., cloud access management client 240) and local clients (e.g., local client 250). The cloud access management client 240 and device management client 242 provide administrators with tools to manage hybrid AI workload execution, device provisioning, and policy enforcement. Local users interact with the hybrid compute management engine 210 through the local client 250 and remote desktop client 252, enabling access to AI workloads through the hybrid compute infrastructure.

The hybrid compute management engine 210 operates through a structured AI workload lifecycle, beginning with the provisioning and configuration of remote clients. The provisioning engine 160A ensures that remote clients (e.g., remote client 102A) are fully equipped with hybrid AI compute resources, enabling them to execute AI workloads either on the remote client 102A or through offloading mechanisms. Once provisioned, AI workload execution begins when a user on a remote client 102A or local client 250 initiates an AI-powered feature. The AI processing orchestrator 120A evaluates workload execution paths based on policies stored in the AI workload management policy store 130A. If remote client is feasible, the AI workload is processed within the remote client 102A. If the task exceeds local processing capabilities, the workload dispatcher initiates offloading through the data transport layer 128, routing the request to the AI workload router 140A, which determines the most efficient execution path.

When offloading is required, the workload is transmitted to the AI workload distribution engine 170A, which assigns the AI processing task to an appropriate cloud-based compute resource. An AI model execution unit executes the AI model using cloud-based inference engines, supporting various AI workloads such as image recognition, natural language processing, and/or OCR-based document retrieval. Once processing is complete, inference results are sent back through the AI workload router 140A and transmitted to the remote client 102A, ensuring that AI-driven computations integrate seamlessly with the user’s workflow.

In this way, a hybrid compute management system enables scalable, policy-driven AI workload execution, overcoming the limitations of traditional virtualized desktop infrastructures by leveraging a cloud-based AI workload compute resource dynamically. Through a structured combination of workload routing, distribution, provisioning, and policy enforcement, the system ensures optimal performance and efficient utilization of AI computing power across a distributed hybrid environment.

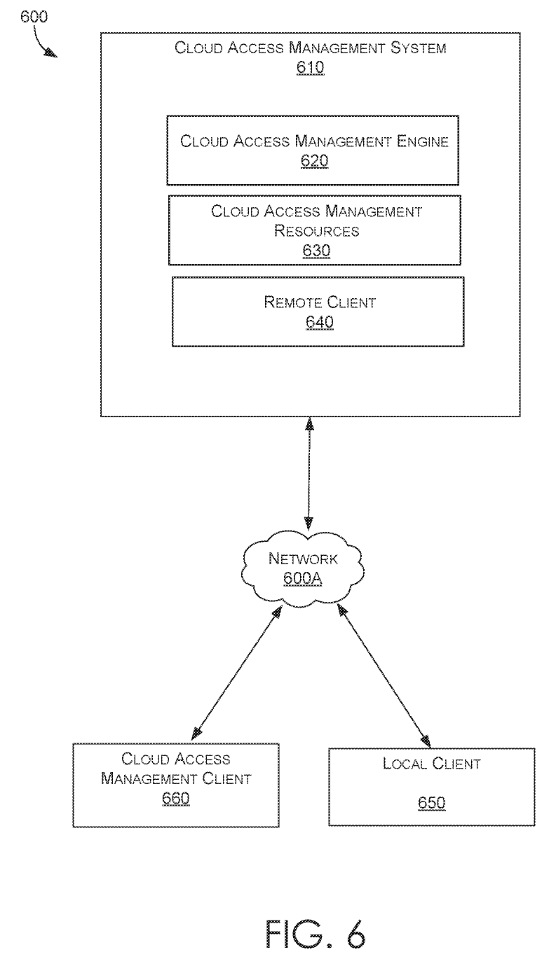

Aspects of the technical solution have been described by way of examples and with reference to FIGS. 1A, 1B and 2. FIG. 1A is a block diagram of an exemplary technical solution environment, based on example environments described with reference to FIGS. 6, 7 and 8 for use in implementing embodiments of the technical solution are shown. Generally, the technical solution environment includes a technical solution system suitable for providing the example cloud computing system 100 in which methods of the present disclosure may be employed. In particular, FIG. 1A illustrates a high-level architecture of the cloud computing system 100 in accordance with implementations of the present disclosure, among other engines, managers, generators, selectors, or components not shown (collectively referred to herein as “components”).

### Example Methods

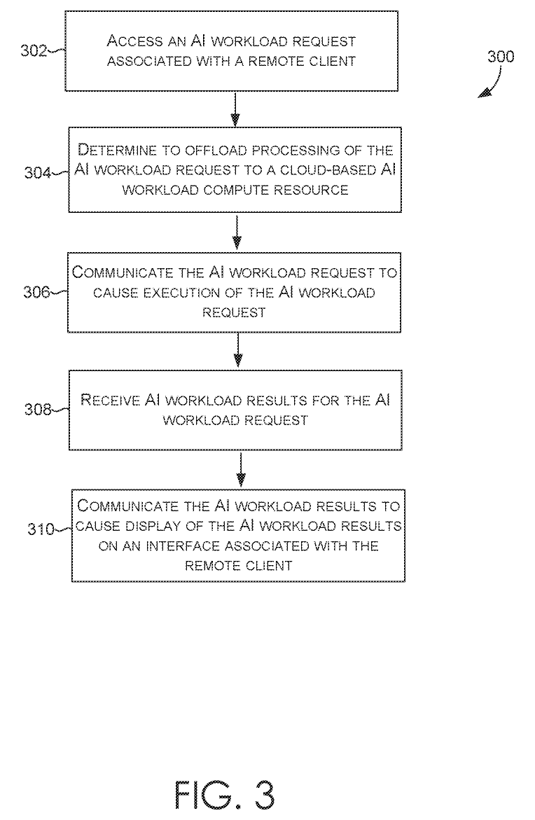

With reference to FIGS. 3, 4, and 5, flow diagrams are provided illustrating methods for providing hybrid compute management using a hybrid compute management engine in a cloud access management system. The methods may be performed using the cloud access management system described herein. In embodiments, one or more computer-storage media having computer-executable or computer-useable instructions embodied thereon that, when executed, by one or more processors can cause the one or more processors to perform the methods (e.g., computer-implemented method) in the cloud access management system (e.g., a computerized system).

Turning to FIG. 3, a flow diagram is provided that illustrates a method 300 for providing hybrid compute management using a hybrid compute management engine in a cloud access management system. At block 302, access, at an artificial intelligence (AI) processing orchestrator, an AI workload request associated with a remote client. At block 304, based on an AI workload management policy, determine to offload processing of the AI workload request to a cloud-based AI workload compute resource. At block 306, communicate the AI workload request to the cloud-based AI workload compute resource to cause execution of the AI workload request. At block 308, in response to communicating the AI workload request, receive AI workload results for the AI workload request. At block 310, communicate AI workload results to cause display of the AI workload results on an interface associated with the remote client.

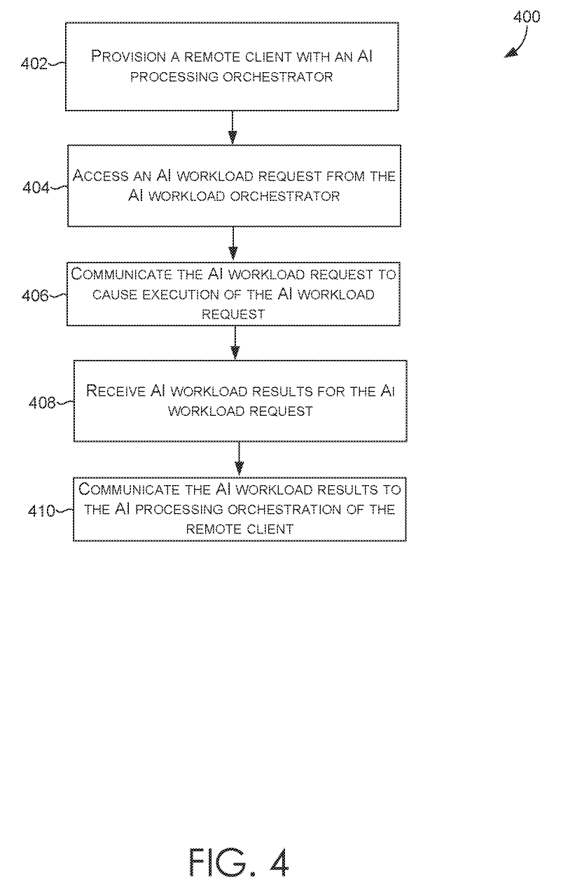

Turning to FIG. 4, a flow diagram is provided that illustrates a method 400 for providing hybrid compute management using a hybrid compute management engine in a cloud access management system. At block 402, provision a remote client with an artificial intelligence (AI) processing orchestrator that supports offloading AI workload from the remote client based on AI workload management policies. At block 404, access, at an AI workload router, an AI workload request from the AI processing orchestrator, wherein the AI workload request is identified for processing via an AI workload distribution engine comprising a cloud-based AI workload compute resource. At block 406, communicate the AI workload request to the cloud-based AI workload compute resource to cause execution of the AI workload request. At block 408, in response to communicating the AI workload request, receive AI workload results for the AI workload request. At block 410, communicate the AI workload results to the AI processing orchestrator to cause display of the AI workload results on an interface associated with the remote client.

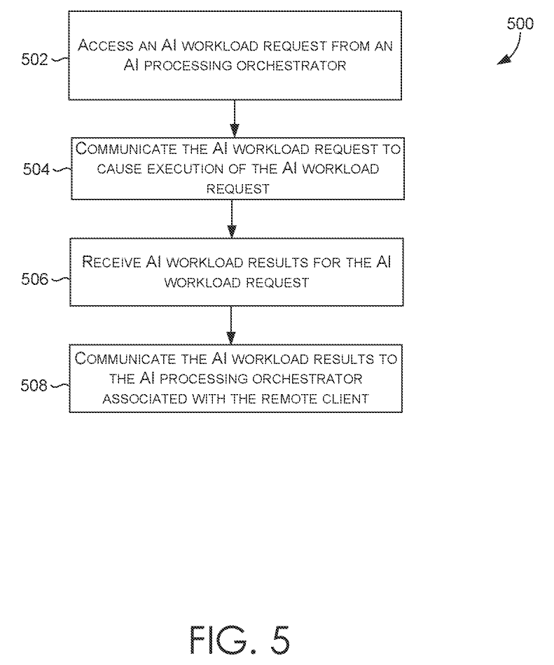

Turning to FIG. 5, a flow diagram is provided that illustrates a method 500 for providing hybrid compute management using a hybrid compute management engine in a cloud access management system. At block 502, access, at an artificial intelligence (AI) workload router, an AI workload request from an AI processing orchestrator, wherein the AI workload request is identified for processing via an AI workload distribution engine comprising a cloud-based AI workload compute resource. At block 504, communicate the AI workload request to the cloud-based AI workload compute resource to cause execution of the AI workload request. At block 506, in response to communicating the AI workload request, receive AI workload results for the AI workload request. At block 508, communicate the AI workload results to the AI processing orchestrator to cause display of the AI workload results on an interface associated with a remote client.

### Technical Improvement

Embodiments of the present techniques have been described with reference to several inventive features (e.g., operations, systems, engines, and components) associated with a cloud access management system. Inventive features described include: operations, interfaces, data structures, and arrangements of computing resources associated with providing the functionality described herein relative with reference to a hybrid compute management engine. Functionality of the embodiments of the present technical solution have further been described, by way of an implementation and anecdotal examples – to demonstrate that the operations for providing the hybrid compute management engine as a solution to a specific problem in device management technology to improve computing operations in cloud access management systems.

By way of example, the AI processing orchestrator dynamically determines whether an AI workload should be executed on a remote client or offloaded. The AI processing orchestrator applies policy-based workload management to enforce execution rules, ensuring efficient AI inferencing across devices. If remote client execution is not viable, the workload offloading mechanism transfers AI workloads from remote client to external compute environments. The AI processing orchestrator ensures AI tasks are securely offloaded to cloud-based workload compute resources (e.g., a processor farm). The AI processing orchestrator preserves seamless execution, allowing users to experience AI-powered features without disruption. The transport layer facilitates fast, low-latency data transfer between remote clients and external AI compute resources.

The AI processing orchestrator's dynamic workload execution offers a technical advantage by optimizing AI inferencing efficiency across devices. By applying policy-based workload management, it automates execution decisions, ensuring optimal compute utilization. The workload offloading mechanism enables seamless AI execution, overcoming hardware limitations inherent in virtual desktop infrastructures (VDIs). The transport layer’s low-latency data transfer enhances real-time AI performance, improving user experience and computational efficiency. The hybrid compute management engine reduces processing latency, optimizes resource allocation, and enables scalable, AI-powered hybrid compute environments, strengthening patent eligibility arguments.

### Additional Support for Detailed Description Example Cloud Access Management in a Computing Environment

Referring now to FIG. 6, FIG. 6 illustrates a computing environment in which implementations of the present disclosure may be employed. In particular, FIG. 6 shows a high-level architecture of an example cloud computing environment 600 and cloud access management system 610 that can host a technical solution environment. It should be understood that this and other arrangements described herein are set forth only as examples. For example, as described above, many of the elements described herein may be implemented as discrete or distributed components or in conjunction with other components, and in any suitable combination and location. Other arrangements and elements (e.g., machines, interfaces, functions, orders, and groupings of functions) can be used in addition to or instead of those shown.

The cloud computing system 100 provides computing system resources for different types of managed computing environments. For example, the cloud computing platform supports delivery of computing services – including compute, servers, storage, databases, networking, and intelligence. The components of cloud computing environment 600 may communicate with each other over a network 600A which may include, without limitation, one or more local area networks (LANs) and/or wide area networks (WANs).

The cloud access management system 610 provides cloud access management functionality for different types of cloud computing offerings. The cloud access management system can be a centralized platform designed to facilitate secure and efficient access to a cloud-based AI workload compute resource from various devices, including traditional desktops, laptops, and thin clients. The cloud access management system can include software, hardware, and infrastructure components that enable users to authenticate, connect, and interact with remote resources hosted in the cloud. The cloud access management system manages operations associated with user identities, permissions, and access policies to ensure that only authorized users can access specific resources. Additionally, it may incorporate features such as single sign-on (SSO), multi-factor authentication (MFA), and session management to enhance security and user experience.

Cloud access management system 610 enables secure and efficient access for local clients to remote resources, such as remote clients, through a centralized platform. It encompasses authentication mechanisms to verify the identities of users and devices seeking access, including multi-factor authentication for enhanced security. Authorization protocols govern user permissions and access levels, dictating which resources or applications each user can utilize. Session management functionalities handle the establishment, monitoring, and termination of user sessions, optimizing performance while ensuring compliance with security policies. The cloud access management system also manages connections between local clients and remote clients, employing robust encryption and data integrity measures to protect sensitive information during transmission.

The cloud access management system 610 includes a cloud access management engine 620 that is a computing environment that supports executing computational tasks associated with the cloud access management system 610. The cloud access management engine 620 can be a hardware or software component that performs computational operations, such as, mathematical calculations, data processing, and algorithm execution. The cloud access management system 610 integrates cloud access management resources 630 into cloud access management system 610 to effectively provide cloud access management in a computing environment.

The cloud access management resources 630 refer to computing elements (e.g., components, capability, or entities) that collectively enable the cloud access management engine 620 operations. The cloud access management resources 630 encompass a spectrum of computing elements, beginning with the diverse operations the cloud access management resources 630 can perform, ranging from complex computations to data manipulations. Interfaces, an integral part of the cloud access management resources 630, provide the means for both user interaction and seamless integration with external systems, ensuring a dynamic and interactive computing experience. The data facet of the cloud access management resources 630 involves various types: input data, which is the information provided for processing; processing data, representing the data manipulated during computational tasks; and output data, the results generated by the cloud access management engine 620. In this way, the cloud access management resources 630 support the broader cloud access management engine 620 and cloud access management system 610.

The cloud access management resources can include hybrid compute management resources that encompass the core operations, interfaces, and data components within cloud access management system 200A, collectively supporting its functionality in overseeing diverse devices across the cloud computing system 100. Operations within the hybrid compute management engine 210 speculative resource access, prefetching, speculation handling, machine learning, resource caching, and speculation timeout mechanisms. These operations are facilitated through interfaces such as speculation management, remote resource access, cache management, machine learning integration, and user interaction interfaces. Data components include speculation metadata, cached resource data, user interaction data, and speculation policies, which collectively inform speculation management decisions. Through these interconnected elements, the system aims to optimize resource utilization, reduce latency, and enhance user experience by intelligently anticipating and managing access to remote resources.

The cloud access management system 610 provisions remote clients (e.g., remote client 640). A remote client 640 can be virtual desktop environment (e.g., Desktop as a Service – DaaS). The remote client 640 leverages virtualization, cloud computing, and network technologies to deliver scalable, secure, and cost-effective virtual desktop environments to users, enabling flexible remote access to computing resources from any location, on any device. DaaS providers provide Virtualized Desktop Infrastructures (VDI) that host virtual desktops on servers in their data centers. These virtual desktops are created using virtualization technologies such as hypervisors or containerization platforms. Each virtual desktop includes an operating system, applications, data, and user settings.

The local client 650 connects to the remote client 640. The local client 650 can be a software application or device installed or used on the end-user's local hardware, such as a desktop computer, laptop, thin client, or mobile device. This client software facilitates the remote connection to the VDI hosted by the remote client provider, allowing end-users to access their virtual desktop environments over the internet. Local client 650 can be a managed client that is centrally controlled and monitored by cloud access management system 610. Managed clients typically have device management software installed or configured on them, allowing administrators to enforce security policies, configure settings, deploy applications, and perform remote management tasks. The local client 650 can be an unmanaged client that operates independently without being centrally controlled or monitored. These devices lack device management software or configurations, and users have full control over their settings and applications.

The cloud access management client 660 supports access to cloud access management system 610. Cloud access management client 660 provides a graphical or command-line interface for users or administrators to monitor and manage user sessions to ensure proper termination, timeout, and session activity logging. Configuring authentication methods such as passwords, multi-factor authentication (MFA), biometrics, or single sign-on (SSO) to verify user identities, and setting up authorization rules and permissions to govern user access to specific resources, applications, or data. The cloud access management client 660 supports centralized access management within a computing environment empowering efficient access administration.

### Example Distributed Computing System Environment

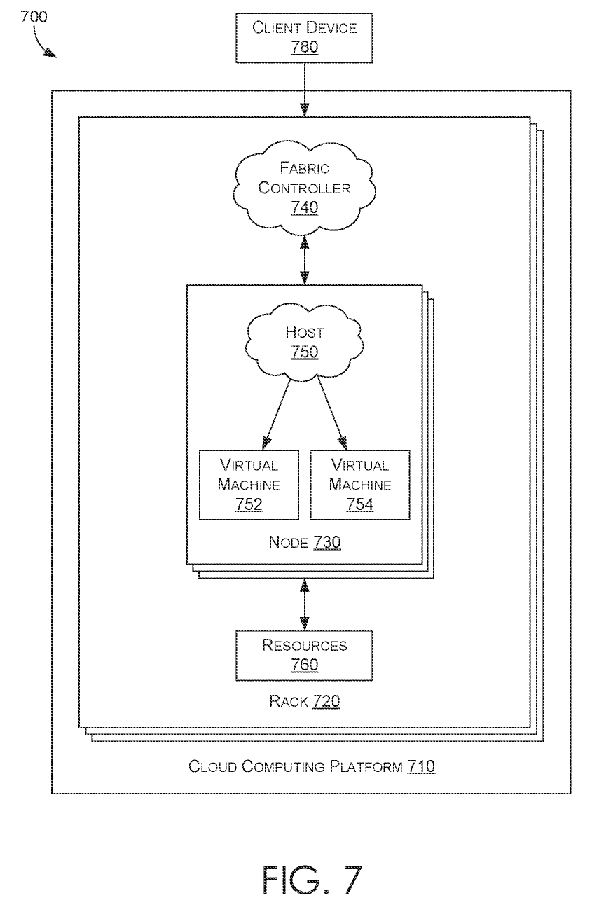

Referring now to FIG. 7, FIG. 7 illustrates an example distributed computing environment 700 in which implementations of the present disclosure may be employed. In particular, FIG. 7 shows a high level architecture of an example cloud computing platform 710 that can host a technical solution environment, or a portion thereof (e.g., a data trustee environment). It should be understood that this and other arrangements described herein are set forth only as examples. For example, as described above, many of the elements described herein may be implemented as discrete or distributed components or in conjunction with other components, and in any suitable combination and location. Other arrangements and elements (e.g., machines, interfaces, functions, orders, and groupings of functions) can be used in addition to or instead of those shown.

Data centers can support distributed computing environment 700 that includes cloud computing platform 710, rack 720, and node 730 (e.g., computing devices, processing units, or blades) in rack 720. The technical solution environment can be implemented with cloud computing platform 710 that runs cloud services across different data centers and geographic regions. Cloud computing platform 710 can implement fabric controller 740 component for provisioning and managing resource allocation, deployment, upgrade, and management of cloud services. Typically, cloud computing platform 710 acts to store data or run service applications in a distributed manner. Cloud computing platform 710 in a data center can be configured to host and support operation of endpoints of a particular service application. Cloud computing platform 710 may be a public cloud, a private cloud, or a dedicated cloud.

Node 730 can be provisioned with host 750 (e.g., operating system or runtime environment) running a defined software stack on node 730. Node 730 can also be configured to perform specialized functionality (e.g., compute nodes or storage nodes) within cloud computing platform 710. Node 730 is allocated to run one or more portions of a service application of a tenant. A tenant can refer to a customer utilizing resources of cloud computing platform 710. Service application components of cloud computing platform 710 that support a particular tenant can be referred to as a multi-tenant infrastructure or tenancy. The terms service application, application, or service are used interchangeably herein and broadly refer to any software, or portions of software, that run on top of, or access storage and compute device locations within, a datacenter.

When more than one separate service application is being supported by nodes 730, nodes 730 may be partitioned into virtual machines (e.g., virtual machine 752 and virtual machine 754). Physical machines can also concurrently run separate service applications. The virtual machines or physical machines can be configured as individualized computing environments that are supported by resources 760 (e.g., hardware resources and software resources) in cloud computing platform 710. It is contemplated that resources can be configured for specific service applications. Further, each service application may be divided into functional portions such that each functional portion is able to run on a separate virtual machine. In cloud computing platform 710, multiple servers may be used to run service applications and perform data storage operations in a cluster. In particular, the servers may perform data operations independently but exposed as a single device referred to as a cluster. Each server in the cluster can be implemented as a node.

Client device 780 may be linked to a service application in cloud computing platform 710. Client device 780 may be any type of computing device, which may correspond to computing device 800 described with reference to FIG. 7, for example, client device 780 can be configured to issue commands to cloud computing platform 710. In embodiments, client device 780 may communicate with service applications through a virtual Internet Protocol (IP) and load balancer or other means that direct communication requests to designated endpoints in cloud computing platform 710. The components of cloud computing platform 710 may communicate with each other over a network (not shown), which may include, without limitation, one or more local area networks (LANs) and/or wide area networks (WANs).

### Example Computing Environment

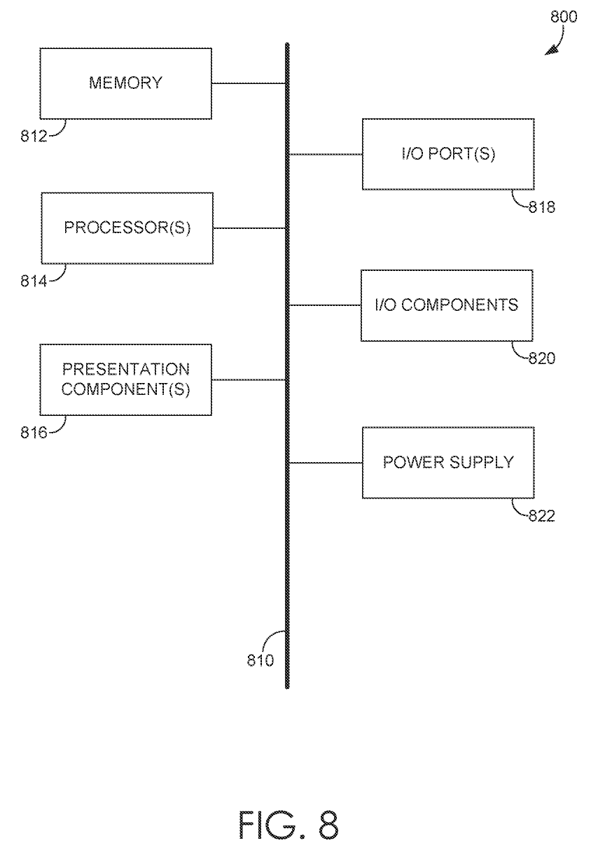

Having briefly described an overview of embodiments of the present technical solution, an example operating environment in which embodiments of the present technical solution may be implemented is described below in order to provide a general context for various aspects of the present technical solution. Referring initially to FIG. 8 in particular, an example operating environment for implementing embodiments of the present technical solution is shown and designated generally as computing device 800. Computing device 800 is but one example of a suitable computing environment and is not intended to suggest any limitation as to the scope of use or functionality of the technical solution. Neither should computing device 800 be interpreted as having any dependency or requirement relating to any one or combination of components illustrated.

The technical solution may be described in the general context of computer code or machine-useable instructions, including computer-executable instructions such as program modules, being executed by a computer or other machine, such as a personal data assistant or other handheld device. Generally, program modules including routines, programs, objects, components, data structures, etc. refer to code that perform particular tasks or implement particular abstract data types. The technical solution may be practiced in a variety of system configurations, including hand-held devices, consumer electronics, general-purpose computers, more specialty computing devices, etc. The technical solution may also be practiced in distributed computing environments where tasks are performed by remote-processing devices that are linked through a communications network.

With reference to FIG. 8, computing device 800 includes bus 810 that directly or indirectly couples the following devices: memory 812, one or more processors 814, one or more presentation components 816, input/output ports 818, input/output components 820, and illustrative power supply 822. Bus 810 represents what may be one or more buses (such as an address bus, data bus, or combination thereof). The various blocks of FIG. 8 are shown with lines for the sake of conceptual clarity, and other arrangements of the described components and/or component functionality are also contemplated. For example, one may consider a presentation component such as a display device to be an I/O component. Also, processors have memory. We recognize that such is the nature of the art and reiterate that the diagram of FIG. 8 is merely illustrative of an example computing device that can be used in connection with one or more embodiments of the present technical solution. Distinction is not made between such categories as “workstation,” “server,” “laptop,” “hand-held device,” etc., as all are contemplated within the scope of FIG. 8 and reference to “computing device.”

Computing device 800 typically includes a variety of computer-readable media. Computer-readable media can be any available media that can be accessed by computing device 800 and includes both volatile and nonvolatile media, removable and non-removable media. By way of example, and not limitation, computer-readable media may comprise computer storage media and communication media.

Computer storage media include volatile and nonvolatile, removable and non-removable media implemented in any method or technology for storage of information such as computer-readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by computing device 800. Computer storage media excludes signals per se.

Communication media typically embodies computer-readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of any of the above should also be included within the scope of computer-readable media.

Memory 812 includes computer storage media in the form of volatile and/or nonvolatile memory. The memory may be removable, non-removable, or a combination thereof. Exemplary hardware devices include solid-state memory, hard drives, optical-disc drives, etc. Computing device 800 includes one or more processors that read data from various entities such as memory 812 or I/O components 820. Presentation component(s) 816 present data indications to a user or other device. Exemplary presentation components include a display device, speaker, printing component, vibrating component, etc.

I/O ports 818 allow computing device 800 to be logically coupled to other devices including I/O components 820, some of which may be built in. Illustrative components include a microphone, joystick, game pad, satellite dish, scanner, printer, wireless device, etc.

### Additional Structural and Functional Features of Embodiments of the Technical Solution

Having identified various components utilized herein, it should be understood that any number of components and arrangements may be employed to achieve the desired functionality within the scope of the present disclosure. For example, the components in the embodiments depicted in the figures are shown with lines for the sake of conceptual clarity. Other arrangements of these and other components may also be implemented. For example, although some components are depicted as single components, many of the elements described herein may be implemented as discrete or distributed components or in conjunction with other components, and in any suitable combination and location. Some elements may be omitted altogether. Moreover, various functions described herein as being performed by one or more entities may be carried out by hardware, firmware, and/or software, as described below. For instance, various functions may be carried out by a processor executing instructions stored in memory. As such, other arrangements and elements (e.g., machines, interfaces, functions, orders, and groupings of functions) can be used in addition to or instead of those shown.

Embodiments described in the paragraphs below may be combined with one or more of the specifically described alternatives. In particular, an embodiment that is claimed may contain a reference, in the alternative, to more than one other embodiment. The embodiment that is claimed may specify a further limitation of the subject matter claimed.

The subject matter of embodiments of the technical solution is described with specificity herein to meet statutory requirements. However, the description itself is not intended to limit the scope of this patent. Rather, the inventors have contemplated that the claimed subject matter might also be embodied in other ways, to include different steps or combinations of steps similar to the ones described in this document, in conjunction with other present or future technologies. Moreover, although the terms “step” and/or “block” may be used herein to connote different elements of methods employed, the terms should not be interpreted as implying any particular order among or between various steps herein disclosed unless and except when the order of individual steps is explicitly described.

For purposes of this disclosure, the word “including” has the same broad meaning as the word “comprising,” and the word “accessing” comprises “receiving,” “referencing,” or “retrieving.” Further the word “communicating” has the same broad meaning as the word “receiving,” or “transmitting” facilitated by software or hardware-based buses, receivers, or transmitters using communication media described herein. In addition, words such as “a” and “an,” unless otherwise indicated to the contrary, include the plural as well as the singular. Thus, for example, the constraint of “a feature” is satisfied where one or more features are present. Also, the term “or” includes the conjunctive, the disjunctive, and both (a or b thus includes either a or b, as well as a and b).

For purposes of a detailed discussion above, embodiments of the present technical solution are described with reference to a distributed computing environment; however the distributed computing environment depicted herein is merely exemplary. Components can be configured for performing novel aspects of embodiments, where the term “configured for” can refer to “programmed to” perform particular tasks or implement particular abstract data types using code. Further, while embodiments of the present technical solution may generally refer to the technical solution environment and the schematics described herein, it is understood that the techniques described may be extended to other implementation contexts.

For purposes of this disclosure the word “support” refers to provisioning of functionality, services, or assistance by a computing component or through computing operations within a broader computing system. When a computing component or set of operations supports a specific functionality, it means that it plays a role in enabling or executing that particular aspect of the computing system. This support can manifest in various ways, including the processing of data, execution of operations, management of resources, and ensuring compatibility or interoperability with other components. Additionally, support may involve providing interfaces, APIs (Application Programming Interfaces), or protocols that allow seamless interaction and integration with other elements of the computing system. The concept of support extends beyond mere functionality provision to encompass maintenance, troubleshooting, and the overall optimization of computing resources to ensure the robust and efficient operation of the computing system.

Embodiments of the present technical solution have been described in relation to particular embodiments which are intended in all respects to be illustrative rather than restrictive. Alternative embodiments will become apparent to those of ordinary skill in the art to which the present technical solution pertains without departing from its scope.

From the foregoing, it will be seen that this technical solution is one well adapted to attain all the ends and objects hereinabove set forth together with other advantages which are obvious and which are inherent to the structure.

It will be understood that certain features and sub-combinations are of utility and may be employed without reference to other features or sub-combinations. This is contemplated by and is within the scope of the claims.

What is claimed is:

1. A computerized system comprising:
one or more computer processors; and
computer memory storing computer-useable instructions that, when used by the one or more computer processors, cause the one or more computer processors to perform operations, the operations comprising:
accessing, at an artificial intelligence (AI) processing orchestrator, an AI workload request associated with a remote client;
based on an AI workload management policy, determining to offload processing of the AI workload request to a cloud-based AI workload compute resource;
communicating the AI workload request to the cloud-based AI workload compute resource to cause execution of the AI workload request;
in response to communicating the AI workload request, receiving AI workload results for the AI workload request; and
communicating the AI workload results to cause display of the AI workload results on an interface associated with the remote client.

2. The system of claim 1, wherein the AI processing orchestrator operates with a virtual runtime environment agent to dynamically execute AI-powered features using the cloud-based AI workload compute resource.

3. The system of claim 1, wherein the AI processing orchestrator employs an AI execution framework, a task scheduler, a workload dispatcher, and a data transport layer to execute AI workloads associated with AI inferencing across local, cloud, and remote computing environments.

4. The system of claim 1, wherein the AI workload management policy instructs the AI processing orchestrator to offload AI workloads based on a type of AI task.

5. The system of claim 1, wherein the cloud-based AI workload compute resource is associated with an AI workload distribution engine to process AI workloads using machine learning endpoints.

6. The system of claim 1, wherein an AI workload router manages AI workload interactions between the remote client and the cloud-based AI workload compute resource for hybrid compute management.

7. The system of claim 1, wherein the remote client is provisioned with hybrid compute AI processing resources to support dynamically offloading AI workload based on AI workload management policies.

8. One or more computer-storage media having computer-executable instructions embodied thereon that, when executed by a computing system having a processor and memory, cause the processor to perform operations, the operations comprising:
provisioning a remote client with an artificial intelligence (AI) processing orchestrator that enables offloading AI workloads from the remote client based on AI workload management policies;
accessing, at an AI workload router, an AI workload request from the AI processing orchestrator, wherein the AI workload request is indicated for processing via an AI workload distribution engine comprising a cloud-based AI workload compute resource;
communicating the AI workload request to the cloud-based AI workload compute resource to cause execution of the AI workload request;
in response to communicating the AI workload request, receiving AI workload results for the AI workload request; and
communicating the AI workload results to the AI processing orchestrator to cause display of the AI workload results on an interface associated with the remote client.

9. The media of claim 8, wherein the AI processing orchestrator operates with a virtual runtime environment agent to dynamically execute AI-powered features using the cloud-based AI workload compute resource.

10. The media of claim 8, wherein the AI processing orchestrator employs an AI execution framework, a task scheduler, a workload dispatcher, and a data transport layer to execute AI workloads associated with AI inferencing across local, cloud, and remote computing environments.

11. The media of claim 8, wherein an AI workload management policy instructs the AI processing orchestrator to offload AI workloads based on a type of AI task.

12. The media of claim 8, wherein the AI workload router manages AI workload interactions between the remote client and the cloud-based AI workload compute resource for hybrid compute management.

13. The media of claim 8, wherein the cloud-based AI workload compute resource is associated with an AI workload distribution engine to process AI workloads using machine learning endpoints.

14. The media of claim 8, wherein the remote client is provisioned with hybrid compute AI processing resources to support dynamically offloading AI workload based on AI workload management policies.

15. A computer-implemented method, the method comprising:
accessing, at an artificial intelligence (AI) workload router, an AI workload request from an AI processing orchestrator, wherein the AI workload request is indicated for processing via an AI workload distribution engine comprising a cloud-based AI workload compute resource;
communicating the AI workload request to the cloud-based AI workload compute resource to cause execution of the AI workload request;
in response to communicating the AI workload request, receiving AI workload results for the AI workload request; and
communicating the AI workload results to the AI processing orchestrator to cause display of the AI workload results on an interface associated with a remote client.

16. The method of claim 15, wherein the AI processing orchestrator operates with a virtual runtime environment agent to dynamically execute AI-powered features using the cloud-based AI workload compute resource.

17. The method of claim 15, wherein the remote client is provisioned with hybrid compute AI processing resources to support dynamically offloading AI workload based on AI workload management policies.

18. The method of claim 15, wherein the cloud-based AI workload compute resource is associated with an AI workload distribution engine to process AI workloads using machine learning endpoints.

19. The method of claim 15, wherein an AI workload router manages AI workload interactions between the remote client and the cloud-based AI workload compute resource for hybrid compute management.

20. The method of claim 15, wherein an AI workload management policy instructs the AI processing orchestrator to offload AI workloads based on a type of AI task.
